(19) United States
(12) Patent Application Publication
(10) Pub. No.: US 2008/0162034 A1
(43) Pub. Date: Jul. 3, 2008

(54) System and method for automatically generating sets of geo-fences

(75) Inventor: Thomas Bernard Breen, Broomall, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: General Electric Company

(21) Appl. No.: 11/648,437

(22) Filed: Dec. 28, 2006

(51) Int. Cl. G01C 21/26

(52) U.S. Cl. 701/202; 701/201

(57) ABSTRACT

A system and method for automatically generating a set of geo-fences to be used by a telematics device mounted on a mobile asset in tracking the mobile asset traveling from a starting location to and ending location, wherein the set of geo-fences is selected from a library of geo-fences based an expected route of travel between the starting location and the ending location and one or more criteria.

### BACKGROUND OF THE INVENTION

Companies that use large fleets of vehicles or tracked assets are subject to misuse or theft of their fleet vehicles. (The terms “vehicle” and “asset” are used interchangeably herein to indicate a cargo trailer or other similar piece of equipment that may travel from one location to another or may stored for a time in a location.) For example, it is likely that some vehicles in a large fleet will be used by employees without authorization or will at least occasionally be subject to theft. Even employees who are authorized to use a vehicle for some purposes may, in some instances, deviate from an authorized route or otherwise make an unauthorized use of the vehicle. One way to reduce these problems is to install a monitoring system to track the location of vehicles in a fleet. Such telematics devices can enable a fleet manager to monitor the location of vehicles in the fleet to determine when they are located in un-authorized areas, or are being used at un-authorized times.

Several solutions to the problem of tracking and monitoring objects to be tracked have been tried or implemented with varying levels of success. Widely used procedures for monitoring the movement of fleet vehicles involve the use of geo-fencing, or establishing an electronic boundary around areas, landmarks, or locations of interest. Typically, a geo-fence is used to provide a zone, often a set radius, around the location of the vehicle or around the location of a fixed landmark such as a customer facility or a central distribution point. A geo-locator, such as a Geographic Positioning System (GPS) receiver, is installed in the tracked asset or vehicle to monitor the location of the vehicle relative to the geo-fence. The geo-locator may be linked with a processor on the asset for determining whether the vehicle crosses a geo-fence boundary or remains within a geo-fence.

The event of the vehicle crossing a geo-fence boundary can trigger the processor to send an alert or message to a central location indicating that the vehicle has moved through a geo-fence. Typically, an alert is be triggered when the vehicle enters or exits a geo-fenced zone, such as where the geo-fence defines a location at which the vehicle is being stored, loaded, or unloaded, or a route on which the vehicle is expected to travel. To implement such a system, a set of geo-fences must be generated to correspond to each vehicle being tracked at any point in time.

Libraries of geo-fences may be generated and stored to facilitate repeated reuse of the same geo-fences to track different assets at the same location or traveling the same route, or to track the same asset in the same location or traveling the same route at different periods of time. Typically, the libraries may include geo-fences pertaining to locations where an asset may be expected to be, such as distribution centers, customer facilities, and maintenance depots, as well as roads, bridges, tunnels, waterways, and other byways.

Problems with using such a system to track assets include the need to manually assemble massive quantities of sets of geo-fences from the libraries of geo-fences, particularly when the central station is responsible for managing a large fleet of vehicles that travel between numerous distribution centers and customer facilities on a multitude of routes. In order to effectively implement this system of vehicle tracking, a new geo-fence set must generally be generated for each vehicle whenever that vehicle begins a new task. Such tasks include, but are not limited to, delivering goods from one location to another (including loading and unloading the goods from the vehicle) and sitting in storage in one location for a length of time. Generation of a geo-fence set involves determining the expected location or route of travel of the vehicle between one location and another and selecting relevant geo-fences based on a range of available criteria. That set of geo-fences is then loaded into the telematics devices mounted on the vehicle. Typically, a set of geo-fences is selected manually by an operator for loading into the memory of the telematics device for each particular asset and for each particular task.

Problems with using such a system to track assets further include the production of massive quantities of alerts or messages emanating from tracked assets as those assets cross various geo-fences, the alerts or messages often being far more than the central station can effectively prioritize and handle. In order to effectively implement this system of vehicle or asset tracking, particularly with regard to a large fleet, it is desirable to reduce the number of alerts that are produced while increasing the pertinence of those alerts, thereby enabling the central station to manage risks to the fleet as a whole, and/or to individual assets, by focusing on the most important situations which a geo-fence tracking system might detect.

Accordingly, there is a need for a system and method for automatically generating sets of geo-fences to be loaded onto the asset-mounted telematics unit based on one or more criteria, and in particular for automatically generating sets of geo-fences that will make improved use of the often limited resources to process and respond to alerts.

### SUMMARY OF THE INVENTION

Accordingly, the present invention is directed to a system and method of automatically generating sets of geo-fences to monitor the location of mobile assets.

In one embodiment, the invention comprises a method of automatically generating a set of geo-fences for loading in to a memory of a telematics device on a mobile asset, wherein the telematics device has a location device and wherein the telematics device is capable of wirelessly communicating with a central station. The method comprises generating a library of geo-fences, determining a starting location and an ending location for the mobile asset, determining an expected route of travel for the mobile asset between the starting location and the ending location, determining one or more criteria for the selection of geo-fences along the expected route of travel, and selecting one or more geo-fences to form the set of geo-fences by applying the one or more criteria to the library of geo-fences.

In another embodiment, the invention comprises a system for automatically generating a set of geo-fences for tracking a mobile asset, comprising: a mobile asset having a telematics device comprising a memory, a location device, and a wireless communications system; and a central station having a library of geo-fences, fences, a processor, and a wireless communications system capable of communicating with the wireless communications system of the telematics device. The processor is adapted to receive mobile asset information including a starting location and an ending location. The processor is further adapted to determine an expected route of travel between the starting location and the ending location. The processor is still further adapted to determine one or more criteria for the selection of geo-fences along the expected route of travel. The processor is yet further adapted to apply the one or more criteria to the library of geo-fences to select one or more geo-fences to form the set of geo-fences. The set of geo-fences selected by the processor is loaded into the memory of the telematics device

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### DESCRIPTION OF DRAWINGS

FIG. 1 is a block diagram representation of the monitoring and tracking system of an embodiment of the present invention.

FIG. 2 is an exemplary map showing the use of an exemplary set of geo-fences for tracking asset traveling on a particular route in an embodiment of the present invention.

FIG. 3. is a schematic representation of a method of automatically generating a set of geo-fences for use in tracking an asset in an embodiment of the present invention.

FIG. 4. is a schematic representation of a method of using the automatic geo-fence set generation system of an embodiment of the present invention.

### DETAILED DESCRIPTION OF THE PREFERRED EMBODIMENTS

Reference will now be made in detail to an embodiment of the present invention, an example of which is illustrated in the accompanying drawings.

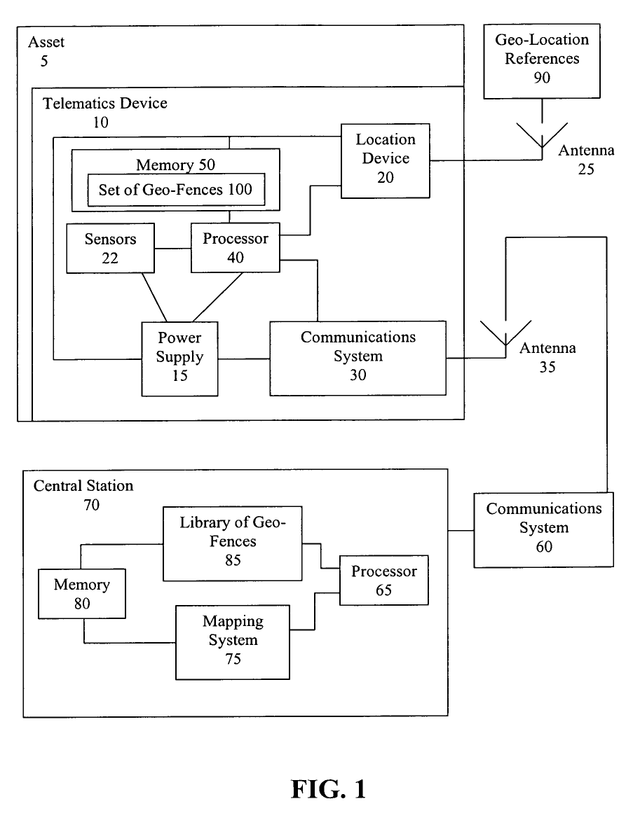

FIG. 1 illustrates a block diagram of a representative system for monitoring the location of an asset 5. The system includes an asset 5 containing a telematics device 10. The telematics device 10 may include the following components: a power supply 15, a location device 20, one or more sensors 22, a communications system 30, a processor 40, and a memory 50, where each of the components is linked to the power supply 15, or contains its own power supply when modular components are used. The location device 20 is connected to an antenna 25 to receive signals from a geo-location references 90, such as satellites. The communications system 30 is connected to the antenna 35 to communicate through a communications system 60 to a central station 70.

The central station 70 is linked to a processor 65 that is in turn linked to a library 85 of geo-fences 130 stored in a memory 80. The memory 80 may also contain information, such as operating parameters 135, associated with each geo-fence 130. The processor 65 of the central station 70 is further linked to a mapping system 75 that is capable of generating routes of travel between various locations based on criteria specified by the processor 65 of the central station 70. The mapping system 75 also may be linked to the memory 80 that may contain mapping data.

The asset 5 represents a vehicle, trailer, or other device for which a position is to be monitored. The telematics device 10 may be single unit which comprises all of the components, or individual components, or groups of components, linked together. The power supply 15 may include fuel cells, dry cells, or other types of battery, and may include at least one solar cell or other energy harvesting device and associated hardware and/or software to power the devices or recharge the battery. The power supply 15 may also include voltage and/or current regulatory circuitry to supply power to other components in the telematics device 10. When the telematics device 10 includes an individual component, that component may contain its own power source or be linked to the power supply 15.

The location device 20 is a position determining system, such as the Global Positioning System (GPS), Differential GPS (DGPS), Eurofix DGPS, and the Global Navigation Satellite System (GLONASS). The present invention is well-suited to use any position determining system (both terrestrial and satellite based) as well as future systems that may be developed, and is not dependent on the use of a particular system. The location device 20 can receive signals through the antenna 25 from external geo-location references 90, such as satellites. The location device 20 may be part of, or integrated with, the transceiver or receiver of the communications system 30. Alternatively, the location device 20 may be a separate device specifically for determining the location of the asset 5, or a receiver integrated within the telematics device 10.

The antenna 25 for the location device 20 may be integrated into the location device 20 or may be a separate component linked to location device 20 either directly or through linkages in the telematics device 10. In an embodiment, the position of the vehicle can be determined using another type of locating system, such as a system of terrestrial towers that transmit signals to and/or receive signals from a receiver/transmitter located in or on the vehicle. Such a system can use propagation times between the vehicle and the terrestrial towers to triangulate the vehicle's position. This type of triangulation system can be implemented, for example, using a cellular telecommunication infrastructure.

The sensors 22 are capable of sensing various conditions of the asset 5, and may include, but are not limited to, thermal sensor to sense the temperature of the asset or the temperature of a part of the asset such as a refrigerated cargo compartment or wheel bearings, motion sensors to sense whether the asset is in motion, door sensors to sense the position of doors or hatches on the asset, valve condition sensors to sense the condition of valves on a tank-car, impact sensors to measure any impact to the asset, speed sensors to measure the speed of the asset, accelerometers to measure the acceleration of the asset, pressure sensors to sense tire pressure on the asset, and content sensors to determine the presence of material in an area such as a cargo in a trailer. In addition, other data can be determined or extracted from data measured with the sensors 22, including maximum and minimum temperature, maximum and minimum speed, total time stopped (using a clock in addition to the motion sensor), total time moving, and average speed.

The communications system 30 may be any wireless system located on the asset 5 which is linked to the processor 40 that allows two-way communications between the telematics device 10 on the asset 5 and the communications system 60 linked to a central station 70. The antenna 35 for the communications system 30 may be integrated into the communications system 30 or may be a separate component which is linked to the communications system 30 either directly or through linkages in the telematics device 10.

The processor 40 may be part of an embedded device (e.g., an onboard computer with limited functionality) or can be a general use processor that is part of the asset 5. The processor 40 is linked to the power supply 15, the location device 20, the sensors 22, the communications system 30, and the memory 50. The memory 50 may be any device, including magnetic, optical or solid-state memory, where information stored in the device may be changed by the user. The memory 50 is used to contain a set of geo-fences 130 and information 135 (such as operating parameters) associated with each geo-fence, the set of geo-fences and associated parameters being specific to the asset and the task being tracked.

The central station 70 may be any facility having a communications system 60 capable of two way communications with the communications system 30 in the telematics device 10. The communication system 60 can be a public or private wireless network that allows two way communications between the central station 70 and the communications system 30 on the telematics device 10. The communications system 60 and the communications system 30 are compatible for transferring data on geo-fences 130 and associated information 135 between the processor 65 linked to the central station 70 and the processor 40 on the telematics device 10 on the asset 5.

The geo-location references 90 utilized will depend upon the location device 20. When a GPS receiver 20 is used, the geo-location references 90 will comprise a portion of the set of GPS (also known as NAVSTAR) satellites. In other types of geo-location systems, the geo-location references 90 could be cellular communication towers, or other locations/system which provide reference points utilized by the location device 20.

The processor 65 may be any microprocessor capable of accepting user inputs, accessing the library of geo-fences 85 and the mapping system 75, and generating a set of geo-fences pertinent to a particular asset 5 engaging in a particular task, based on the data comprising user inputs, geo-fences stored in the library 85, and mapped routes.

The geo-fences 130 stored in the library 85 may be based on various locations or landmarks where it may be desirable for the telematics device 10 to operate under particular sets of parameters. For example, geo-fences 130 may be based on the location of the asset 5 itself, the location of a fixed landmark where the asset 5 is expected to travel or be located for some period of time, such as a customer's facility or a central distribution point, or the location of a fixed landmark where an asset 5 should not be located or should be located for only a short amount of time or only with heightened monitoring.

The geo-fences 130 may be generated and stored into the library 85 to facilitate repeated reuse of the same geo-fences 130. For example, the same geo-fence 130 may be used to track different assets at the same location or traveling the same route, or to track the same asset in the same location or route at different periods of time. Typically, such libraries 85 include geo-fences 130 pertaining to locations where an asset may be expected to be, such as distribution centers, customer facilities, and maintenance depots, as well as roads, bridges, tunnels, waterways, and other byways. Additionally, the libraries 85 may include geo-fences 130 pertaining to locations that are off-limits to the asset, including specific locations and deviations from the bounds of preferred or expected routes of travel, as well as locations to which the asset may travel but only for limited periods of time or under close supervision and monitoring.

The library 85 also may be used to store operating parameters 135 or other information associated with each geo-fence 130. The operating parameters 135 may include, but are not limited to, information such as actions to be taken when the asset 5 is determined to have entered or exited a particular geo-fence 130, actions to be taken when an asset 5 remains within a particular geo-fence 130 for a period of time, or actions to be taken when the distance between an asset 5 and a particular geo-fence 130 increases or decreases in a particular direction. Specific examples of such actions include: issuing an alert to the central station 70, increasing or decreasing the frequency of monitoring of the sensors 22, increasing or decreasing the frequency with which the telematics device 10 transmits data to the central station 70, and altering the type of data transmitted by the telematics device 10 to the central station 70. A combination of these and other operating parameters 135 may be associated with each geo-fence 130 to customize the functions performed by the telematics device 10 in response to entering, exiting, or remaining within any particular geo-fence.

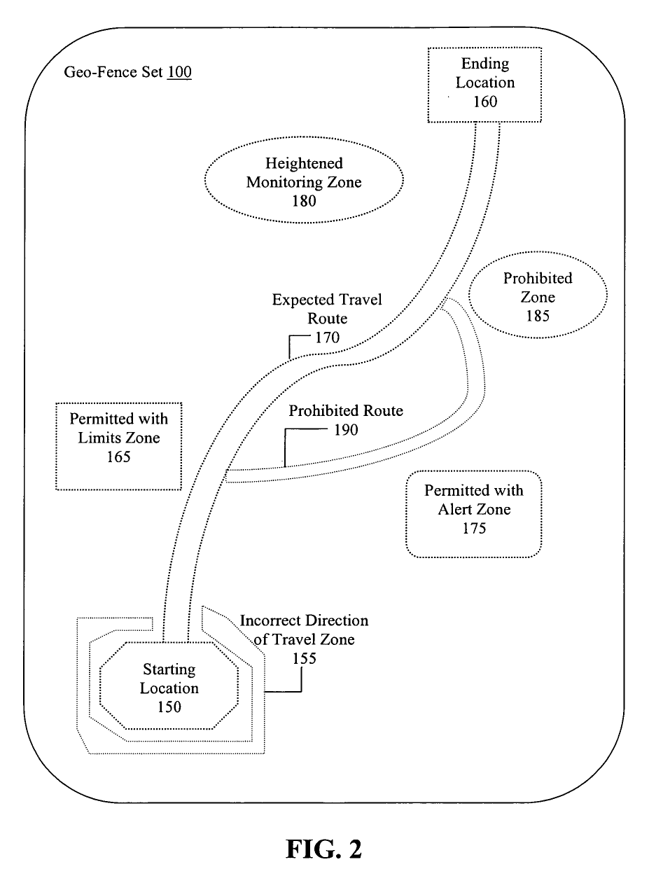

The utility of a customized set of geo-fences 130 is best shown by example, which is not intended to limit the scope of the invention. FIG. 2 shows a map schematic illustrating an exemplary set 100 of geo-fences that may be generated for an asset 5 traveling between two locations, such as a distribution center and a customer facility, along an expected travel path or route. Geo-fences in the set 100 shown on the map are indicated corresponding to boundaries around various landmarks, including a starting location 150, an ending location 160, an expected travel route 170, an incorrect direction of travel zone 155, a permitted with limits zone 165, an permitted with alert zone 175, a heightened monitoring zone 180, a prohibited zone 185, and a prohibited route 190.

Nonlimiting examples of a starting location 150 include a distribution center, a fleet facility, a warehouse, or a customer facility. Nonlimiting examples of an ending location 160 include a distribution center, a fleet facility, a warehouse, or a customer facility. Nonlimiting examples of a permitted with limits zone 165 include a gas station, a restaurant, or a hotel. Nonlimiting examples of a permitted with alert zone 175 include a service facility, a maintenance shop, or a truck stop. Nonlimiting examples of a heightened monitoring zone 180 include a high-theft truck stop or a high-crime neighborhood. Nonlimiting examples of a prohibited zone 185 include a gambling establishment or a tavern. Nonlimiting examples of a prohibited route 190 include a low-bridge route or a windy road not well-suited for commercial traffic.

Each geo-fence is defined by coordinates (e.g., GPS coordinates, latitude/longitude, or other coordinates depending on the geo-referencing system used) chosen to represent the geo-fence. A geo-fence around a landmark or zone 150, 160, 165, 175, 180, or 185 may range in complexity from a circle or rectangle to a highly irregular shape which follows a complex perimeter around the facility. A geo-fence along or around a route 170 or 190, or defining a zone indicating an incorrect direction of travel 155 may range in complexity from a line or rectangle which approximates the route of travel to a highly irregular shape which more accurately follows the route or bounds entrances and exist to a facility or landmark. There are a number of methods for constructing these geo-fences which will be apparent to one skilled in the art.

A method used by the present invention to effectively manage the quantity of alerts and data transmitted by the telematics device 10 to the central station 70 is to implement a form of management by exception in combination with the traditional management by route adherence or compliance. Conventional geo-fence tracking systems may manage route adherence or compliance by generating a geo-fence or series of geo-fences encompassing the entire expected route of travel 170, providing updates or alerts at a frequency while the asset 5 is within the expected route 170 and providing updates or alerts at an increased frequency if the asset 5 leaves the expected route 170. In addition to the production of large number of alerts that provide limited useful information, the difficulties with this approach include the necessity to generate a geo-fence that accurately follows an expected route of travel yet leaves a driver flexibility to use alternate routes, for example to avoid road construction or traffic congestion, without the telematics device 10 triggering excessive and superfluous alerts back to the central station 70. The method of the present invention refines the risk management provided by conventional systems by adding the ability to focus on exceptions to an expected route of travel 170.

In broad outline, the event of the vehicle 5 crossing a geo-fence boundary 130 may be used to trigger the processor 40 of the telematics device 10 to send an alert or message to the central location 70 indicating that the vehicle 5 has moved through a geo-fence, depending on the particular operating parameters associated with the geo-fence that has been entered or exited. Typically, an alert may be triggered when the vehicle enters or exits a geo-fenced zone, such as where the geo-fence defines a location at which the vehicle is being stored, loaded, or unloaded, or a route on which the vehicle is expected to travel. In other cases, an alert may be triggered when the vehicle enters a geo-fenced zone, such as where the geo-fence defines a location that is off-limits to the vehicle or is a deviation from the route or direction which the vehicle is expected to travel.

To implement such a system, the set of geo-fences loaded into the telematics device 10 on each asset 5 is custom-generated to correspond to each vehicle 5 being tracked at any point in time. The parameters 135 associated with each geo-fence 130 within that set will determine whether and when alerts are generated or actions are taken by the telematics device 10 for various events, including entering, exiting, and/or remaining too long within a geo-fence 130. Depending on the location of the asset 5 with relation to any of the set of geo-fences 130 stored on the telematics device 10, an action may be taken. One type of action may be the transmittal of an alert from the telematics device 10 to the central station 70. This transmittal may also include the unique identification of the asset 5. The alert may be selected from a set of alerts, each varying in degree of urgency, and may provide an indication of relative distance or time, among other parameters. At one level of alert, the fleet dispatch manager can contact the driver of the vehicle to inquire about the nature of the deviation from the predefined route. Other levels of alert may result in activating an automatic telephone messaging service, triggering a pager, or otherwise reporting the event to an owner or customer of the asset being tracked.

With reference to the example geo-fences 130 shown in FIG. 2, the implementation of the method of the present invention may be further described by tracing the path of a hypothetical asset traveling along, and deviating from, the expected route of travel 170. Operating parameters 135 associated with each geo-fence 130 will control the activities of the telematics device 10. A geo-fence defines the boundaries around a starting location such as a distribution center 150 where cargo will be loaded into the asset 5. While within the starting location geo-fence 150, it is expected that, for example, cargo doors or hatches will be opened and closed, cargo will be loaded and/or unloaded, and in the case of a refrigerated trailer, temperature control may not be able to be well-maintained during the period of loading. Accordingly, the operating parameters associated with the starting location geo-fence 150 may disable alerts for the occurrence of such events. However, once the cargo is loaded and the doors are secured, alerts may be enabled by the telematics device 10 to monitor for such events, even while the asset 5 remains within the geo-fence 150.

When the asset 5 exits the starting location geo-fence 150, an alert may, but need not, be generated. At that point, the telematics device 10 may perform any of at least two functions. The telematics device 10 may monitor the location to of the asset 5 to determine whether it enters, and remains within, the expected route of travel 170, in which case, an alert should not be necessary. Additionally, the telematics device 10 may monitor the location of the asset 5 to determine whether it enters the incorrect direction of travel zone 155 indicating that it has departed in an incorrect direction of travel, in which case an alert should be generated. Such an alert will indicate the existence of a problem event to the central station 70, including that the asset trailer 5 has been attached to the wrong tractor, or that the asset 5 has been stolen, or that the driver of the asset 5 is simply lost. If the asset 5 subsequently exits the incorrect direction of travel zone 155, another alert should be generated. In this situation, the telematics device 10 may compare the location of exit to the expected path of travel geo-fence 170 to determine if the asset 5 has traveled closer to, or farther away from, its intended routing in deciding whether to issue an alert.

If the asset 5 subsequently enters the expected path of travel 170, an alert may be generated to indicate that the asset 5 has been restored to its intended routing. As long as the asset 5 remains in motion along the expected travel path geo-fence 170, the telematics device 10 may perform infrequent monitoring of certain sensors 22, such as door and cargo sensors, because of the unlikelihood that these may change, but may perform more frequent monitoring of other sensors 22, such as bearing temperature, tire pressure, and refrigerated trailer temperature. However, if the asset 5 stops moving for more than a set period of time, the telematics device 10 may perform more frequent monitoring, even when the asset remains within the travel path geo-fence 170. The parameters 135 associated with each geo-fence 130 provide instructions to the telematics device 10 regarding the handling of any such contingencies.

When the asset 5 is traveling on its expected path of travel, it may exit the geo-fence 170 for any of several reasons, including a necessary visit to a service station or eating establishment or resting stop, or an unnecessary personal side trip of the driver or passenger. The library 85 of geo-fences contains a vast number of geo-fences 130 so that along any travel path 170, the set of geo-fences loaded into the telematics device 10 may include known landmarks such as permitted with alert zone 175 like a service station or maintenance stop 175, a permitted with limits zone 165 such as gas station or eating establishment or overnight resting stop 165, a heightened monitoring zone 180 such as high-theft zone or truck stop, a prohibited zone 185 such as a gambling establishment or tavern 185, or a prohibited route 190 such as a low-bridge route. Each of these geo-fenced zones 130 may have associated parameters 135 that instruct the telematics device 10 how to respond if the asset 5 enters, exits, or remains within, one of these zones.

In an example, it is expected that from time to time, an asset 5 may leave the travel route 170 because of required repairs or because the driver desires to eat or needs to sleep. Accordingly, if the asset 5 enters a permitted with limits geo-fence 165, it may be unnecessary for the telematics device 10 to issue an alert to the central station 70, but the telematics device 10 may increase its monitoring frequency of certain sensors, including but not limited to the door and cargo sensors, while the asset 5 remains within the geo-fence 165. However, if the asset 5 remains within the geo-fence 165 for longer than a certain period of time (e.g., 15 minutes for a gas station, one hour for a restaurant, or eight hours for an overnight truck stop) the telematics device 10 may generate an alert back to the central station 70. Alternatively, if the asset 5 enters a permitted with alert geo-fence 175, the telematics device 10 should generate an alert immediately to the central station 70 to indicate that there may be a problem with the asset 5 that could delay or impair delivery of the cargo carried by the asset 5. In yet another example, if the asset 5 enters a prohibited route geo-fence 190 known to place the asset 5 on a path that must traverse a low-height or weight-limited bridge or excessively windy road, the telematics device 10 should generate an immediate alert to the central station 70 so that asset 5 can be stopped and rerouted quickly to avoid the costs and loss of time that would otherwise result from having the asset turn around at later time or, worse yet, from having the asset collide with a low-height bridge or damage or collapse a weight-limited bridge or encounter a non-navigable sharp curve.

In another example, it may be undesirable for an asset 5 to be transported to a particular heightened monitoring landmark or location 180, such as a truck stop where there is known to be a high occurrence of thefts. In the event that the asset 5 enters a heightened monitoring geo-fence 180, the telematics device 10 may generate an immediate alert to the central station 70 and may also increase its monitoring frequency of certain sensors 22, including but not limited to the door and cargo sensors, while the asset 5 remains with the geo-fence 180. In yet another example, it may be forbidden for an asset 5 to be transported to a particular forbidden landmark or location 185, such as a gambling establishment or tavern. In the event that the asset 5 enters the off-limits zone geo-fence 185, the telematics device 10 should generate an immediate alert to the central station 70 and may also increase its monitoring frequency of certain sensors 22, including but not limited to the door and cargo sensors, while the asset 5 remains with the geo-fence 185.

The advantages of management by exception include the ability of the central station 70 to concentrate its monitoring and handling of incoming alerts to the most important needs of each asset 5 and of the fleet as a whole. For example, instead of having to filter through large numbers of status updates indicating that assets 5 are traveling within their expected routes 170, the central station 70 can use its sometimes limited resources to monitor and respond to events that may indicate problems, such as an asset traveling in the wrong direction or an asset sitting stationary for too long at a permissible stopping point or an asset entering an off-limits zone, as described in greater detail above.

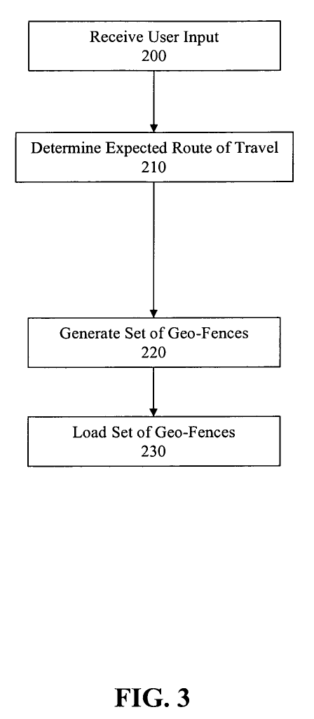

FIG. 3 is a diagram of a method of automatically generating a set of geo-fences for loading into the telematics device 10, comprising receiving a user input 200, determining an expected route of travel 210, generating a set of geo-fences 220, and loading the set of geo-fences into the telematics device on the tracked asset 230. The function of generating a set of geo-fences for loading into a tracked asset is performed by the processor 65 of the central station 70, in cooperation with various other components including the library of geo-fences 85, the mapping system 75, and the memory 80.

In the step of receiving a user input 200, data is entered into the processor 65 indicating the current location of the asset 5, and the origin and destination locations of the task to be performed (e.g., the delivery to be made). Additionally, data may be entered into the processor 65 to indicate further relevant parameters including, but not limited to, the type of cargo, the value of the cargo, the size and weight of the cargo, the required departure and delivery dates and times, the identity of the tractor to which the asset trailer is to be connected, and the identity of the driver.

In the step of determining the expected route of travel 210, the processor 65 interacts with the mapping device 75 to determined a preferred travel route based on certain criteria. The criteria informing route selection may include, but are not limited to, minimization of transport costs, maximization of use of interstates and highways, minimization of travel time, avoidance of low bridges, and avoidance of high loss paths (i.e., where thefts have historically been more common). These criteria may be dependent upon such data as the type, value, size, and weight of the cargo, or may be independently entered and selected. Based on the current, origin, and destination locations of the asset, as well as any other pertinent criteria, the mapping device 75, in conjunction with the memory 80 capable of storing mapping and routing data, computes an expected route or routes of travel. Various mapping devices, systems, and methods are known in the art, and any of such, as well as any future developed device, system, or method, may be used in conjunction with the present invention.

In the step of generating a set of geo-fences 220, the processor 65 interacts with the library of geo-fences 85 to determine which geo-fences 130 stored in the memory 80 should be loaded into the telematics device 10 on the asset 5 for use while the asset 5 travels along the expected route of travel 170 that has been generated by the mapping system 75 for the current task. The criteria informing geo-fence set generation may include, but are not limited to, the type, value, size, and weight of the cargo, the distance and expected duration of the trip, the historic theft rate along the expected route of travel, a threshold distance of deviation from the expected route of travel, and may even include the characteristics of the particular driver.

In the step of loading the set of geo-fences 230, the processor 65 and central station 70 may interact with the communications system 60 to transmit the set of geo-fences to the communication system 30 of the telematics device 10, or the set of geo-fences may be loaded locally from the central station 70 to the telematics device 10 by other means.

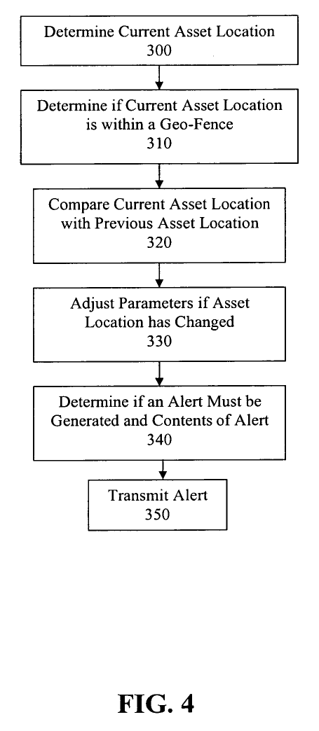

FIG. 4 is a diagram of the method of monitoring the location of an asset relative to a set of geo-fences 130 and associated parameters 135 which are loaded into the telematics device 10, and utilizing that set of geo-fences and associated parameters to generate alerts as appropriate. In the step of determining the current asset location 300, the location device 20 receives signals from the geo-location references 90 and communicates the current location information to the central processor 40. The current location is stored into the memory 50 on the asset 5, which may also retain a number of prior locations in order to monitor and assess the progress of travel of the asset 5 over time.

In the step of determining if the current location is within a geo-fence 310, the processor 40 compares the current location of the asset 5 with the boundaries of the geo-fences in the set stored in the memory 50 of the telematics device 10 on the asset 5. To determine whether the asset 5 is located within a particular geo-fence 130, the positional coordinates of the current location of the asset 5 is compared with the coordinates of the area defined by the geo-fence 130. If the current location is not within the geo fence being considered, the processor 40 can compare the current location with another geo-fence stored in the memory 50 on the asset 5, repeating the process until either a geo-fence 130 is identified within which the asset 5 is located, or it is determined that the asset is not within any of the set of geo-fences stored in the memory 50 on the asset 5. Other methods of data comparison, whether known or to be discovered, may also be used by the processor 40.

In the step of comparing the current location with the previous location 320, the processor 40 compares the current location with the immediate previous location stored in the memory 50 and determines if the asset 5 has crossed a boundary of (i.e., has entered or exited) a geo-fence. If the asset 5 has entered into or exited from a geo-fence 130, the telematics device 10 may adjust monitoring parameters, if required.

In the step of adjusting monitoring parameters 330, the processor 40 compares the operating parameters 135 associated with the geo-fence 130 with a set of default operating parameters for use when the asset 5 is not located within any geo-fence. If the asset 5 has just entered a geo-fence 130 requiring different operating parameters 135 from the default, then the geo-fence specific operating parameters are loaded from memory 50. If the asset 5 has just departed from a geo-fence 130 requiring different operating parameters 135 from the default, then the default operating parameters are loaded from memory 50. If the geo-fence operating parameters are the same as the default operating parameters, then no action may be required.

In the step determining if an alert must be generated and the contents of the alert 340, the processor 40 may evaluate various circumstances. Regardless whether has been necessary to adjust monitoring parameters in the step 330, in the step 340, the processor 40 determines whether an alert must be generated and transmitted to the central station 70, and the content of any alert that must be generated and transmitted. In one circumstance, the operating parameters 135 associated with a particular geo-fence 130 may specify that an alert should or should not be generated upon entry into or exit from the geo-fence, or upon remaining within the geo-fence beyond a specified duration of time. The operating parameters 135 may also specify the type of alert to be generated and transmitted to the central station 70. In another circumstance, the operating parameters 135 associated with a particular geo-fence 130 may specify that an alert should or should not be generated upon a signal from one or more of the sensors 22 of a change in conditions while within the geo-fence. Other circumstances may be envisioned when it may be necessary or desirable for the processor 40 to generate and transmit an alert to the central station 70.

In the step of transmitting an alert 350, the processor 40 transmits an alert to the central station 70 if it has determined in the step 340 than an alert is required. An alert may contain information including but not limited to the time of the alert condition, position of the asset, the speed of the asset, the direction of travel of the asset, the status of sensors 22 on the asset, and the expected time to destination for the asset.

In addition to a multitude of commercial uses, the system and accompanying methods of the present invention may have significant uses with regard to homeland security in that they can provide an automated system that requires minimal human intervention to enable tracking vehicles carrying hazardous, dangerous, or valuable cargo, or prevention or recovery of such vehicles and cargo from being stolen or tampered with during their transit. Similarly, the system and method of the present invention may be used to prevent vehicles from being use for unauthorized or illegal purposes.

It is to be understood that the present invention is not limited to the embodiments described above, but encompasses any and all embodiments within the scope of the following claims.

What is claimed is:

1. A method of automatically generating a set of geo-fences for loading into a memory of a telematics device on a mobile asset, wherein the telematics device has a location device and wherein the telematics device is capable of wirelessly communicating with a central station, comprising:
generating a library of geo-fences;
determining a starting location for the mobile asset;
determining an ending location for the mobile asset;
determining an expected route of travel for the mobile asset between the starting location and the ending location;
determining one or more criteria for the selection of geo-fences along the expected route of travel; and
selecting one or more geo-fences to form the set of geo-fences by applying the one or more criteria to the library of geo-fences.

2. The method of claim 1, wherein the library of geo-fences includes operating parameter data associated with at least one geo-fence for controlling actions of the telematics device with respect to the geo-fence with which the operating parameter data is associated.

3. The method of claim 2, wherein the operating parameter data indicates one or more actions to be taken by the telematics device when the location device determines that the mobile asset has entered the geo-fence with which the operating parameter data is associated.

4. The method of claim 2, wherein the operating parameter data indicates one or more actions to be taken by the telematics device when the location device determines that the mobile asset has exited the geo-fence with which the operating parameter data is associated.

5. The method of claim 2, wherein the operating parameter data indicates one or more actions to be taken by the telematics device when the location device determines that the mobile asset has remained for a period of time within the geo-fence with which the operating parameter data is associated.

6. The method of claim 2, wherein the operating parameter data indicates one or more actions to be taken by the telematics device when the location device determines that the mobile asset has moved farther from the geo-fence with which the operating parameter data is associated.

7. The method of claim 2, wherein the operating parameter data indicates one or more actions to be taken by the telematics device when the location device determines that the mobile asset has moved nearer to the geo-fence with which the operating parameter data is associated.

8. The method of claim 2, wherein the at least one geo-fence having associated operating parameter data defines an area where the asset is expected to be located for a period of time while traveling from the starting location to the ending location.

9. The method of claim 2, wherein the at least one geo-fence having associated operating parameter data defines an area where the asset is permitted to be located for a period of time while traveling from the starting location to the ending location.

10. The method of claim 2, wherein the at least one geo-fence having associated operating parameter data defines an area where the asset is forbidden to be located while traveling from the starting location to the ending location.

11. The method of claim 2, wherein the actions to be taken by the telematics device include communicating an alert to the central station.

12. The method of claim 11, wherein the operating parameter data indicates the level of urgency of the alert and the content of the alert communicated by the telematics device to the central station.

13. The method of claim 2, wherein the operating parameter data enables the telematics device to communicate with the central station only when the mobile asset deviates from the expected route of travel.

14. The method of claim 13, wherein the telematics device is enabled to communicate with the central station when the mobile asset exits a geo-fence where the asset is expected to be located while traveling from the starting location to the ending location.

15. The method of claim 13, wherein the telematics device is enabled to communicate with the central station when the mobile asset remains for a period of time within a geo-fence where the asset is permitted to be located while traveling from the starting location to the ending location.

16. The method of claim 13, wherein the telematics device is enabled to communicate with the central station when the mobile asset enters a geo-fence where the asset is forbidden to be located while traveling from the starting location to the ending location.

17. The method of claim 2, wherein the telematics device further includes at least one sensor to sense the condition of the mobile asset and wherein the actions to be taken by the telematics device include increasing or decreasing the frequency of monitoring of the at least one sensor.

18. The method of claim 17, wherein the conditions sensed on the mobile asset include at least a material condition selected from the group consisting of temperature, motion, door position, valve condition, impact, speed, acceleration, impact, pressure, presence of cargo in the asset, and combinations thereof.

19. The method of claim 2, wherein the actions to be taken by the telematics device include increasing or decreasing the frequency with which the telematics device communicates with the central station.

20. The method of claim 2, wherein the actions to be taken by the telematics device include increasing or decreasing the frequency with which the telematics device determines the current location of the mobile asset.

21. The method of claim 1, wherein the central station comprises a mapping system for automatically determining the expected route of travel of the mobile asset based upon the starting location and the ending location.

22. The method of claim 1, wherein the criteria for the selection of geo-fences includes a threshold distance from the expected route of travel of the mobile asset.

23. The method of claim 1, wherein the mobile asset is transporting cargo and the criteria for the selection of geo-fences includes the value of the cargo.

24. The method of claim 1, wherein the mobile asset is transporting cargo and the criteria for the selection of geo-fences includes the size of the cargo.

25. The method of claim 1, wherein the mobile asset is transporting cargo and the criteria for the selection of geo-fences includes the weight of the cargo.

26. The method of claim 1, wherein the criteria for the selection of geo-fences includes the historical theft rate along the expected route of travel of the mobile asset.

27. The method of claim 1, wherein the criteria for the selection of geo-fences includes characteristics of the driver of the mobile asset.

28. A system for automatically generating a set of geo-fences for tracking a mobile asset, comprising:
a mobile asset having a telematics device comprising a memory, a location device, and a wireless communications system;
a central station having a library of geo-fences, a processor, and a wireless communications system capable of communicating with the wireless communications system of the telematics device; and
wherein the processor is adapted to receive mobile asset information including a starting location and an ending location;
wherein the processor is adapted to determine an expected route of travel between the starting location and the ending location;
wherein the processor is adapted to determine one or more criteria for the selection of geo-fences along the expected route of travel; and
wherein the processor is adapted to apply the one or more criteria to the library of geo-fences to select one or more geo-fences to form the set of geo-fences; and
wherein the set of geo-fences selected by the processor is loaded into the memory of the telematics device.

29. The system of claim 28, wherein the processor includes an automatic mapping system for determining an expected route of travel.

30. The system of claim 28, wherein the criteria for the selection of geo-fences includes a threshold distance from the expected route of travel of the mobile asset.

31. The system of claim 28, wherein the mobile asset is transporting cargo and the criteria for the selection of geo-fences includes the value of the cargo.

32. The system of claim 28, wherein the mobile asset is transporting cargo and the criteria for the selection of geo-fences includes the size of the cargo.

33. The system of claim 28, wherein the mobile asset is transporting cargo and the criteria for the selection of geo-fences includes the weight of the cargo.

34. The system of claim 28, wherein the criteria for the selection of geo-fences includes the historical theft rate along the expected route of travel of the mobile asset.

35. The system of claim 28, wherein the criteria for the selection of geo-fences includes characteristics of the driver of the mobile asset.

36. The system of claim 28, wherein the library of geo-fences includes operating parameter data associated with at least one geo-fence for controlling actions of the telematics device with respect to the geo-fence with which the operating parameter data is associated.

37. The system of claim 36, wherein the operating parameter data indicates one or more actions to be taken by the telematics device when the location device determines that the mobile asset has entered the geo-fence with which the operating parameter data is associated.

38. The system of claim 36, wherein the operating parameter data indicates one or more actions to be taken by the telematics device when the location device determines that the mobile asset has exited the geo-fence with which the operating parameter data is associated.

39. The system of claim 36, wherein the operating parameter data indicates one or more actions to be taken by the telematics device when the location device determines that the mobile asset has remained for a period of time within the geo-fence with which the operating parameter data is associated.

40. The system of claim 36, wherein the operating parameter data indicates one or more actions to be taken by the telematics device when the location device determines that the mobile asset has moved farther from the geo-fence with which the operating parameter data is associated.

41. The system of claim 36, wherein the operating parameter data indicates one or more actions to be taken by the telematics device when the location device determines that the mobile asset has moved nearer to the geo-fence with which the operating parameter data is associated.

42. The system of claim 36, wherein the actions to be taken by the telematics device include communicating an alert to the central station.

43. The system of claim 42, wherein the operating parameter data indicates the level of urgency of the alert and the content of the alert communicated by the telematics device to the central station.

44. The system of claim 36, wherein the operating parameter data enables to the telematics device to communicate with the central station only when the mobile asset deviates from the expected route of travel.

45. The system of claim 44, wherein the telematics device is enabled to communicate with the central station when the mobile asset exits a geo-fence where the asset is expected to be located while traveling from the starting location to the ending location.

46. The system of claim 44, wherein the telematics device is enabled to communicate with the central station when the mobile asset remains for a period of time within a geo-fence where the asset is permitted to be located while traveling from the starting location to the ending location.

47. The system of claim 44, wherein the telematics device is enabled to communicate with the central station when the mobile asset enters a geo-fence where the asset is forbidden to be located while traveling from the starting location to the ending location.

48. The system of claim 36, wherein the telematics device further includes at least one sensor to sense the condition of the mobile asset and wherein the actions to be taken by the telematics device include increasing or decreasing the frequency of monitoring of the at least one sensor.

49. The system of claim 48, wherein the conditions sensed on the mobile asset include at least a material condition selected from the group consisting of temperature, motion, door position, valve condition, impact, speed, acceleration, impact, pressure, presence of cargo in the asset, and combinations thereof.

50. The system of claim 36, wherein the actions to be taken by the telematics device include increasing or decreasing the frequency with which the telematics device communicates with the central station.

51. The system of claim 36, wherein the actions to be taken by the telematics device include increasing or decreasing the frequency with which the telematics device determines the current location of the mobile asset.

52. A system for automatically generating a set of geo-fences for tracking a mobile asset, comprising:
a mobile asset having a telematics device comprising a memory, a location device, and a wireless communications system;
a central station having a library of geo-fences, a processor, and a wireless communications system capable of communicating with the wireless communications system of the telematics device; and
means for entering mobile asset information into the processor, the mobile asset information including a starting location and an ending location;
wherein the processor comprises means for determining an expected route of travel between the starting location and the ending location, means for determining one or more criteria for the selection of geo-fences along the expected route of travel; and means for applying the one or more criteria to the library of geo-fences to select one or more geo-fences to form the set of geo-fences; and
wherein the set of geo-fences selected by the processor is loaded into the memory of the telematics device.
